(19) United States
(12) Patent Application Publication
(10) Pub. No.: US 2005/0105544 A1
(43) Pub. Date: May 19, 2005

(54) Communication method

(75) Inventors: Juho Pirskanen, Tampere (FI); Kimmo Kettunen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/798,562

(22) Filed: Mar. 12, 2004

(30) Foreign Application Priority Data
Nov. 13, 2003 (GB) 0326483.5

(51) Int. Cl. H04J 3/26

(52) U.S. Cl. 370/432; 370/338; 370/252

(57) ABSTRACT

A communication system and applicable method are disclosed to provide a service to at least one user equipment, and to determine if the service is to be provided to the at least one user equipment by a point to point connection or a point to multipoint connection. The determination takes into account which of the at least one user equipment to which service is providable is able to receive the service.

### FIELD OF THE INVENTION

The present invention to a method and system for communication. In particular, but not exclusively the present invention can be applied to multicast services.

### DESCRIPTION OF THE RELATED ART

A communication system is a facility that enables communication between two or more entities such as user terminal equipment and/or network entity and other nodes associated with the communication system. The communication may comprise, for example voice, electronic mail (email), text messages, data, multimedia and so on.

The communication may be provided via a fixed line and/or wireless communication interfaces. A feature of wireless communication systems is that they provide mobility for the users thereof. Examples of communication systems providing wireless communication include the public land mobile network (PLMN) and wireless data network such as the wireless local area network (WLAN).

A type of PLMN is a cellular communication system. In a cellular system user equipment may access the communication network by access entities known as radio access network. The skilled person knows the basic operational principles and elements of the cellular network and these are therefore not explained in any greater detail. It is sufficient to note that a cell can be defined as a radio access entity that is served by one or several base stations (BS) serving user equipment (UE) via a wireless interface between the base station and the user equipment. Examples of the cellular networks include networks that are based on access systems such as CDMA (code division multiple access), WCDMA (wide band CDMA), TDMA (time division multiple access), FDMA (frequency division multiple access), or SDMA (space division multiple access) and hybrids bids thereof.

A communication system typically operates in accordance with a given standard or specification which sets out what the various elements of the system are permitted to do and how that should be achieved. For example, the standard or specification may define if the user, or more precisely user equipment is provided with a circuit switched service or a packet switched service or both. Communication protocols and/or parameters which should be used for the communication are also defined. For example, the manner in which communication shall be implemented between the user equipment and the elements of the communication network is typically based on a predefined communication protocol. In other words, a specific set of “rules” on which the communication can be based is defined to enable the user equipment to communicate via the communication system.

Standardisation of the so called multi/broadcast multimedia service (MBMS) has been carried out by the third generation partnership project (3GPP). Reference is also made to the 3GPP technical specifications TS23.246 and TS25.346 which specify various features of the MBMS service. These documents are also hereby incorporated by reference.

MBMS provides multimedia services in mobile communication systems. Such broadcasts may be provided on a point to multipoint channel, i.e. a shared channel from the network to multiple user equipment or on a point to point channel i.e. on a dedicated channel from the network to each user equipment.

The multicast mode allows the unidirectional point to multipoint transmission of multimedia data, for example text, audio, picture, video data, from a single point source to a multicast group in a multicast service area. The multicast mode is intended to efficiently use radio/network resources and have data transmitted over a common radio channel. In the multicast mode, there is a possibility for the network to selectively transmit to cells within the multicast service area which contain members of a multicast group. Unlike the broadcast mode, the multicast mode general requires a subscription to the multicast subscription group and then the user joins the corresponding multicast group. The subscription and group joining may be made by the PLMN operator, the user or a third party on their behalf (for example a company).

One problem with the current proposals is that user equipment can join a MBMS service and be joined to that service for a number of hours/days/weeks. For example, a user can subscribe to a MBMS multicast service where the user is provided with updated sports information. However, if the user is using the user equipment for another connection such as a call or the like, the user equipment may be unable to receive the MBMS data. Nevertheless, the user is charged as though he has received that data. Clearly, this is disadvantageous in that the user is charged incorrectly.

With the current MBMS proposals, if the number of users to receive multicast data within a given cell falls below a threshold, the multicast transmission is replaced by point to point transmission to the specific user equipment requiring the multicast service. If a user in fact is not able to receive an MBMS service but is assumed to be able to receive that service, then the incorrect decision may be made as to whether or not the multicast service is to be broadcast to the users or to be sent on a point to point connection.

Embodiments of the present invention aim to address one or more of the problems discussed above.

### SUMMARY OF THE INVENTION

According to a first aspect of the present invention, there is provided a method of communication comprising providing a service to at least one user equipment, determining if said service is to be provided to said at least one user equipment by a point to point connection or a point to multipoint connection, said determining step taking into account which of said at least one user equipment to which said service is providable is able to receive said service.

According to a second aspect of the present invention, there is provided a method of communication comprising activating a service which provides data to user equipment and suspending said service when said user equipment is unable to receive data of said service.

According to a third aspect of the present invention, there is provided a communication system comprising means for providing a service to at least one user equipment and means for determining if said service is to be provided to said at least one user equipment by a point to point connection or a point to multipoint connection, said determining means taking into account which of said at least one user equipment to which said service is providable is able to receive said service.

According to a fourth aspect of the present invention, there is provided a communication system in which a service to at least one user equipment can be provided comprising a node for determining if said service is to be provided to said at least one user equipment by a point to point connection or a point to multipoint connection, said determining means taking into account which of said at least one user equipment to which said service is providable is able to receive said service.

According to a fifth aspect of the present invention, there is provided a node in a communication system in which a service is provided to at least one user equipment, wherein said node is arranged to determining if said service is to be provided to said at least one user equipment by a point to point connection or a point to multipoint connection, said determining taking into account which of said at least one user equipment to which said service is providable is able to receive said service.

According to another aspect of the present invention, there is provided a communication system comprising means for activating a service which provides data to user equipment and means for suspending said service when said user equipment is unable to receive data of said service.

According to another aspect of the present invention a communication system in which a service is activated in which data is provided to user equipment, said system having a node arranged to suspend said service when said user equipment is unable to receive data of said service.

According to another aspect of the present invention a node for a communications system in which a service is activated in which data is provided to user equipment, said node being arranged to suspend said service when said user equipment is unable to receive data of said service.

### BRIEF DESCRIPTION OF THE DRAWINGS

For a better understanding of the present invention, reference will now be made by way of example only to the accompanying drawings in which:

FIG. 1 shows a communication system in which embodiments of the present invention may be incorporated;

FIG. 2 shows the stages of MBMS multicast service provision;

FIG. 3 shows the activation of MBMS multicast service;

FIG. 4 shows the MBMS user equipment linking signalling flow;

FIG. 5 shows the MBMS user equipment de-linking signalling flow;

FIG. 6 shows the suspension of an MBMS multicast service, embodying the present invention; and

FIG. 7 shows the reactivation of a suspended MBMS multicast service; embodying the invention.

### DETAILED DESCRIPTION OF THE PREFERRED EMBODIMENTS

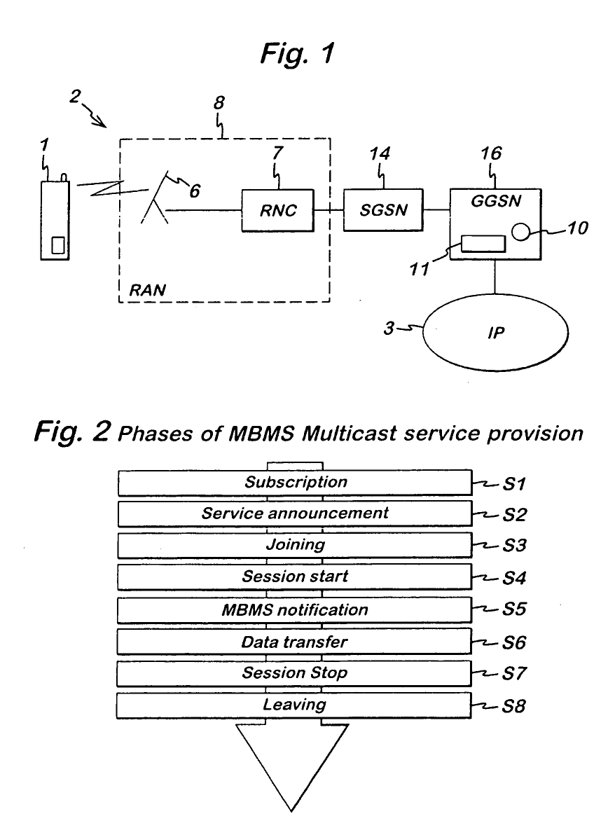

Reference is made to FIG. 1 which shows a communication network in which embodiments of the present invention may be used. The illustrated communication system is capable of providing wireless data transportation services for user equipment 1 by means of a public land mobile network 2. The skilled person is familiar with the features and operation of mobile user equipment. Thus this will not be described in any further detail. It is sufficient to note that the user may use the mobile user equipment for performing tasks such as making and receiving phone calls, receiving content from the network and for experiencing content presented by means of the display and/or the speaker and for interactive correspondence with another party.

The user equipment can take any suitable form and may for example be a mobile station, a mobile telephone, a personal digital assistance (PDA), a laptop computer, a mobile telephone or station connected to a laptop computer or the like, or any other suitable user equipment.

The elements of the PLMN network will now be briefly discussed. The user equipment 1 is arranged to communicate via the air interface with a transceiver element 6 of the radio access network (RAN) 8 of the PLMN. In other words, the communication between the transceiver element 6 of the RAN 8 and the user equipment is via a radio frequency connection.

The transceiver element 6 is a base station. It should be appreciated that the term base station is used in this document to encompass all elements which transmit to and/or receive from user equipment. Depending on the standard, different names may be given to this element. For example, in some standards, the base station is referred to as node B.

The base station is controlled by a radio network controller RNC 7. It should be appreciated that the term radio network controller is used to cover all elements which provide some control of the base station. For example, in some standards, the radio network controller is referred to a base station controller.

The radio network controller RNC and the base station provide a radio access network RAN 8 (for example a UTRAN-UMTS (Universal mobile telecommunications system) terrestrial RAN). It should be appreciated that a UMTS radio access network is typically provided with more than one RNC and that each radio network controller is arranged generally to control more than one base station 6 although only one base station is shown in FIG. 1. Likewise, each base station 6 is only arranged to communicate with more than one user equipment.

The radio access network 8 is connected to the core network of the PLMN system. Typically, the connection will be provided to SGSN (serving GPRS (general packet radio service) support node) 14 on an Iu interface. The SGSN 14 is for providing function such as keeping track of the mobile station location and performing security functions and access control. The SGSN 14 is connected to GGSN (gateway GPRS serving node) 16. The GGSN 16 provides interworking with other communication networks 3. In other words, the GGSN acts as a gateway between the PLMN network to other networks.

FIG. 1 shows a data network and more particularly an IP based data network 3 as an example of such another network. However, it should be appreciated that embodiments of the present invention may be applied to other types of communication arrangements. Therefore, although not shown, the communication system 2 of FIG. 1 may also be connected to conventional telecommunication networks, such as to a GSM based cellular public land mobile network (PLMN) or to a public switch telephone network (PSTN).

Reference will now be made to FIG. 2 which shows the phases of MBMS multicast service provision. This is as currently defined in the known standards.

In the first stage S1, the user subscribes to a particular MBMS service. In the second stage S2, if a MBMA service is available this is announced to the subscribers to that service. In the third stage S3, the subscriber will join the MBMS service. In this join stage, the user equipment indicates it willingness to receive the MBMS service session. This phase is typically performed using a point to point connection and is therefore secure. It allows the sending of session specific parameters in secure form.

In stage S4, the session will start. In stage S5, MBMS notification is sent from the RAN to the user equipment.

In stage S6, data is transferred from the MBMS server to the user equipment. The session stops in stage S7. Finally, in stage S8, the user equipment will leave the session.

It should be appreciated that stages S1 to S8 may be spread out over time. It should be appreciated that a session may for example last a long time, such as hours, days, weeks or even longer with the user equipment receiving MBMS data for a particular service from time to time. In other words the data is provided in an discontinuous manner.

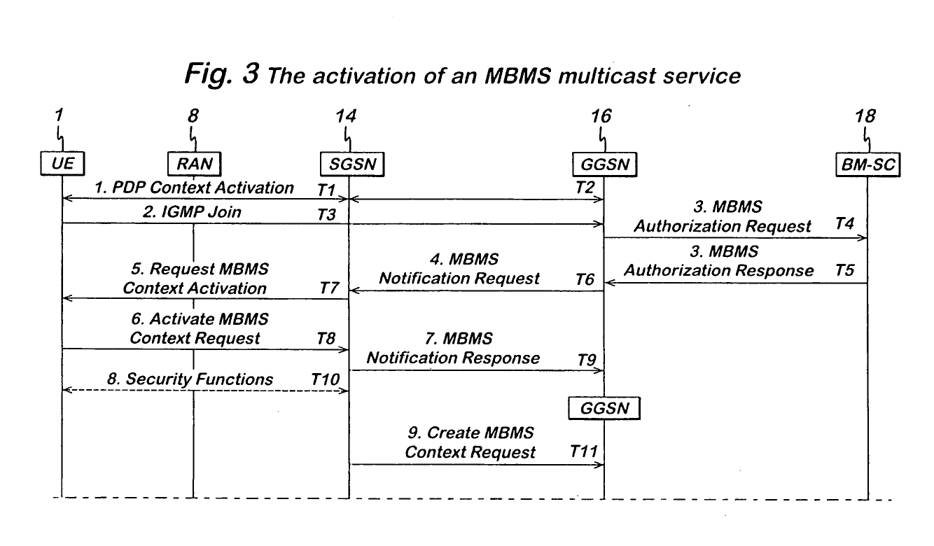

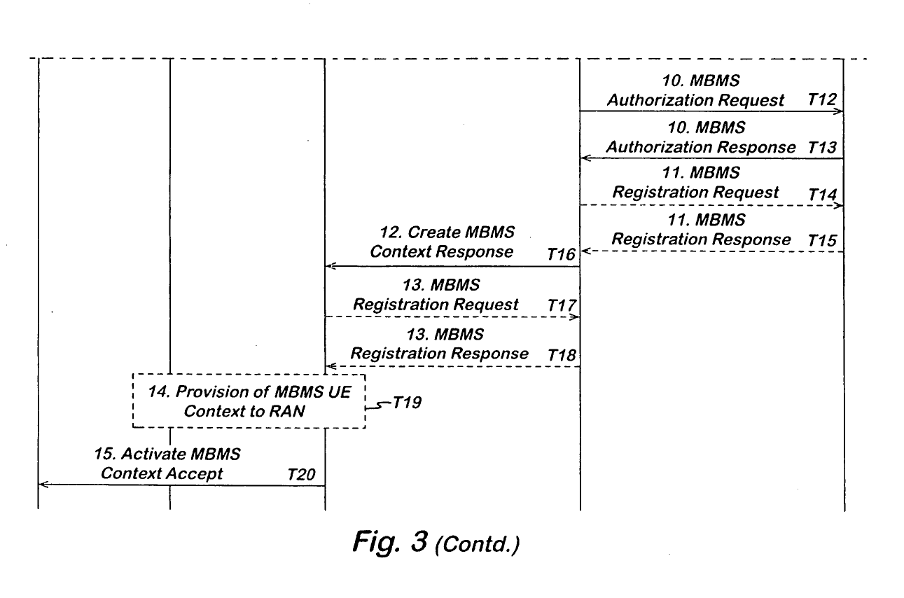

Reference will now be made to FIG. 3 which shows the activation of an MBMS service in more detail. This corresponds to the joining stage shown in FIG. 2.

In step T1, a PDP context is activated between the user equipment and the SGSN 14. In step T2, a PDP context is activated between the SGSN 14 and the GGSN 16. In step T3 a IGMP (Internet group management protocol) join message is sent by the user equipment 1 to the GGSN 16. IGMP is a well known protocol defined by the Internet engineering task force (IETF). The IGMP join message is sent from the application on the user equipment. For example, where a mobile telephone is connected to a lap top, it is the application on the lap top which sends the IGMP join message. In step T4, an MBMS authorisation request is sent to a broadcast/multicast service centre BM-SC 18. The broadcast/multicast service centre is arranged to control the multicast service. The MBMS authorisation request of T4 is to authorise the application.

In step T5, the BM-SC sends a MBMS authorisation response. If the application is authorised, then the authorisation response will indicate this. It is assumed in this example that the application is authorised. In step T6, a MBMS notification request is sent from the GGSN 16 to the SGSN 14.

In step T7, the SGSN 24 requests the initialization of an MBMS context activation procedure, this request being sent to the user equipment. In step T8 the user equipment will request to activate the MBMS context. In response to this, the SGSN 14 sends an MBMS notification response in step T9 to the GGSN 16.

Step T10 may be optional or in the alternative may be carried out a different stage in the procedure. This effectively allows security functions between the user equipment 1 and the SGSN 14 to be implemented.

In step T11, a MBMS context request message is generated by the SGSN 14 and sent to the GGSN 16.

In step T12 a MBMS authorisation request is sent from the GGSM 16 to the BM-SC 18. This is to authorise the user equipment. In step T13 an MBMS authorisation response relating to the user equipment itself is sent from the BM-SC to the GGSM. Thus, steps T4 and T5 relate to the authorisation of the application where as steps T12 and T13 relate to the authorisation of the user equipment.

Steps T14 and T15 are optional. Step T14 comprises MBMS registration request sent from the GGSN 16 to the BM-SC 18. Step T15 comprises a registration response sent from the BM-SC 18 to the GGSN.

A MBMS context response for a SGSN 14 is created in step T16.

Steps T17 and T18 are optional and comprise an MBMS registration request from the new SGSN to the GGSN and a registration response from the GGSN to the new SGSN respectively.

Step T19 may be optional and may for example be provided after step T20. Step T19 is provided when there is a new RNC associated with the user equipment. When that occurs the MBMS user equipment context is provided to the new radio access network.

In step T20, the MBMS context accept is activated. This means that the MBMS data transfer can occur.

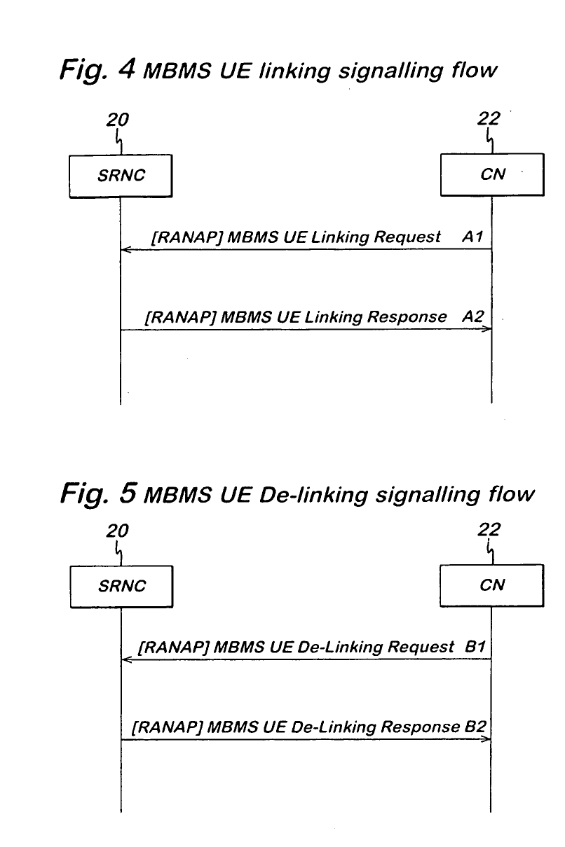

Reference is made to FIG. 4 which shows schematically the signalling between the serving radio network controller (SRNC) 20 and the call network 22. The serving RNC is the RNC which is currently serving a user equipment. The core network comprises elements such as the SGSN and GGSN.

It is currently defined in the relevant standards that only one data stream is established from an upper network node to a lower network node, for example from the BM-SC to a specific GGSN, from the GGSN to one specific SGSN and from the SGSN to a specific RNC. As mentioned previously, it is possible to have both point to point and point to multipoint transmission modes on the air interface and Iub/Iur i.e. the interface between the user equipment and the base station as well as between the RNC and the base station. The point to point mode is used in the cell e.g. when the number of users within the cell is so low (as defined by a threshold) that the point to point transmission is more efficient than point to point. Point to multipoint transmission is used when a number of subscribers is higher than the threshold. Point to point transmission is a transmission between a transmitter and a receiver of data. Point to multipoint transmission is where a single channel is used to transmit data from one transmitter to a plurality of receivers. In this example, the transmitter would be a base station and the receiver would be the user equipment.

The radio network controller can calculate the number of subscribers by existing or established radio resource control connection and Iu signalling connections. The SGSN sends linking information to the serving RNC, this being illustrated by step A1 of FIG. 4 which links the joining of the user equipment in the SGSN to the MBMS service to be transmitted in the UTRAN. Thus, when user equipment joins the service or re-establishes the RRC (radio resource connection) after successful joining, the SRNC 20 will send a response indicating this information in step A2 to the core network 22 (i.e. the SGSN).

Reference is made to FIG. 5 which shows the MBMS user equipment delinking signalling flow. Delinking is defined which is used by the SGSN when the user equipment deactivates the service, moves into the idle state or moves to a different RNC. In step B1 of FIG. 5, the core network sends to the user equipment a de-linking response.

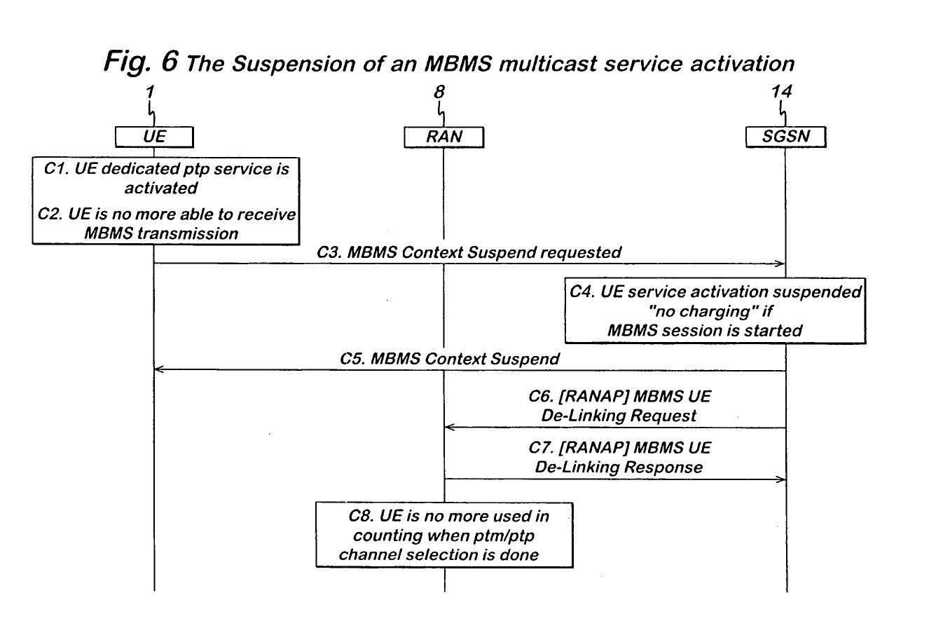

Reference is now made to FIG. 6 which shows schematically the signal flow in an embodiment of the present invention.

In step C1 user equipment is arranged such that another connection such as a dedicated point to point services is activated. This may for example be a call with a third party which may be another user equipment user, a service provider or the like. In step C2, it is determined that the user equipment is not able to receive the MBMS transmission anymore. In some embodiments of the present invention, it is assumed that as soon as the user equipment become involved in another connection that the user equipment is no longer able to receive a MBMS transmission. In other embodiments of the present invention, a determination may be made as to whether or not the user equipment is able to also receive an MBMS transmission at the same time that the user equipment is involved in another connection. This may take into account the connection requirements for both the MBMS transmission and the connection with which the user equipment is involved. Additionally or alternatively, the amount of data is taken into account. Additionally or alternatively the capability of the user equipment is taken into account.

In step C3 when it is determined that the user equipment is no longer able to receive MBMS transmissions, the user equipment sends a MBMS context suspend request to the SGSN.

In step C4, the user equipment service activation is suspended. In other words, there will be no charging of the user for a MBMS transmission. This will be done if an MBMS transmission is started.

In step C5, the SGSN 14 sends a MBMS context suspend message to the user equipment.

In step C6, a MBMS user equipment delinking request is sent to RAN from the SGSN. In practice, this message will be sent to the serving RNC. The serving RNC will reply in step C7 with an MBMS user equipment delinking response. This is similar to the request and responses shown in steps B1 and B2 of FIG. 5.

When the radio access network is making a decision as to whether or not a point to point or point to multipoint channel is to be selected for a given MBMS transmitted, the user equipment for which the MBMS context has been suspended will not be taken into account in that decision. This takes place in step C8.

In other words, only those user equipment which are actually able to receive the MBMS data are taken into account when determining whether or not the point to point or point to multipoint channel is used. This means that there is no over estimating the number of user equipment which are to receive an MBMS transmission. This means that more effective use of the radio resources and indeed the hardware resources can be achieved.

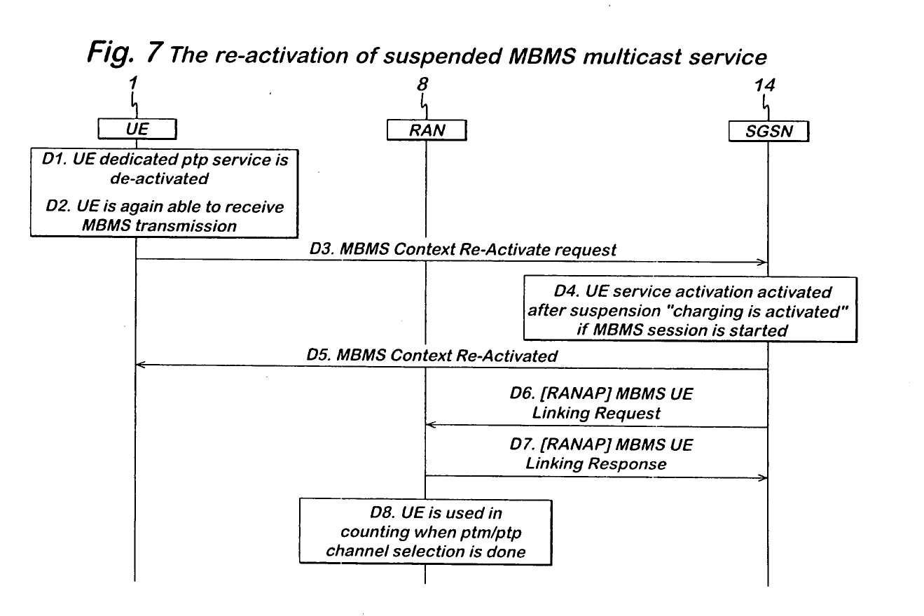

Reference is made to FIG. 7 which shows how a suspended MBMS multicast service can be reactivated.

In step D1, the user equipment other connection such as a dedicated point to point service is deactivated. In other words, the on going connection is terminated in step D2 and it is determined that the user equipment is again able to receive MBMS transmissions. In step D3 the user equipment sends an MBMS context re-activate request to the SGSN 14.

In step D4, the SGSN 14 reactivates the user equipment service. In other words, charging is activated if there is an MBMS session which is started and for which data is being transferred.

A message is sent from the SGSN 14 to the user equipment 1 which reactivates the MBMS context. This takes place in step D5.

In step D6, the MBMS user linking request is sent from the SGSN 14 to the RAN 8. A MBMS user equipment linking response is sent in step D7 from the RAN 8 to the SGSN 14.

In step D8, the RAN 8 and more particularly the RNC serving the user equipment for which the context has been reactivated, will take into account the availability of the user when making a decision as to whether or not to do a point to multipoint or a point to point channel selection.

It should be appreciated that in the embodiments of the present invention described, the RNC is described as being the entity responsible for making a decision as to whether or not a given MBMS transmission is to be point to point or point to multipoint. It should be appreciated that in alternative embodiments of the present invention, other elements of the network may be involved in that decision or make that decision. For example, a base station may be arranged to make that decision. Alternatively, or additionally, the SGSN may be involved in that decision.

It should be appreciated that preferred embodiments of the present invention had been described in the context of the multicast mode of the of MBMS service it should be appreciated that embodiments of the present invention can also be applied to the broad cast service.

Embodiments of the present invention have been described in relation to this specific multimedia broadcast multicast service defined in 3GPP. It should be appreciated that embodiments of the present invention have wider application. Embodiments of the present invention are particularly applicable to scenarios where a user joins a service which periodically provides data in a given session.

Embodiments of the present invention are particularly applicable where charging for a MBMS or similar service is based on the number of data transmissions received by the user equipment.

Embodiments of the present invention allow the user equipment to change from a first state in which it is able to receive MBMS services and a second state in which it is not able to receive MBMS services even when the user is joined to the MBMS service. This means that this information can be taken into account in the MBMS or similar nodes for charging purposes and also the MBMS data distribution. This can also be taken into account in the UTRAN for point to point and point to multipoint selection purposes.

1. A method of communication, the method comprising:
providing a service to at least one user equipment;
determining if said service is to be provided to said at least one user equipment by a point to point connection or a point to multipoint connection, said determining step taking into account which of said at least one user equipment to which said service is providable is able to receive said service.

2. A method as claimed in claim 1, wherein said determining step comprises determining which of said at least one user equipment has a connection.

3. A method as claimed in claim 2, wherein said determining step comprises determining for the at least one user equipment, which has another connection, if said respective at least one user equipment also is able to receive said service.

4. A method as claimed in claim 2, wherein said determining step comprises determining for the at least one user equipment if the at least one user equipment has another connection and determining that said respective at least one user equipment is not able to receive said service if the at least one user equipment has another connection.

5. A method as claimed in claim 1, wherein the determining step comprises determining a number of the at least one user equipment able to receive said service and comparing said determined number with a threshold value.

6. A method as claimed in claim 5, wherein in said determining step comprises determining whether a point to multipoint connection is used if said determined number is greater than said threshold value.

7. A method as claimed in claim 1, wherein the determining step comprises determining the at least one user equipment able to receive said service and charging for said service based on which of the at least one user equipment is able receive said service.

8. A method as claimed in claim 1, further comprising the step of suspending said service for the at least one user equipment if said respective at least one user equipment is unable to receive said service.

9. A method as claimed in claim 8, wherein in said determining step comprises determining if the point to point or the point to multipoint connection is to be used, when the at least one user equipment for which the service has been suspended is not taken into account.

10. A method of communication, the method comprising:
activating a service which provides data to user equipment; and
suspending said service when said user equipment is unable to receive data of said service.

11. A method as claimed in claim 10, wherein said suspending step comprises suspending said service if said user equipment has a different connection.

12. A method as claimed in claim 10, further comprising the steps of
establishing a different connection with said user equipment and
then determining if said user equipment is able to receive data of said service and to perform said suspending service if said user equipment is not able to receive data.

13. A method as claimed in claim 12, wherein said suspending step comprises sending a suspension message from said user equipment to a network element.

14. A method as claimed in claim 13, wherein said suspending step comprises suspending charging for said service.

15. A method as claimed in claim 14, wherein said suspending step comprises suspending charging performed by the network element.

16. A method as claimed in claim 15, wherein said suspending step comprises suspending a context between said user equipment and the network element.

17. A method as claimed in claim 15, wherein said suspending step comprises suspending charging performed by the network element, said network element comprising a serving general packet radio service support node.

18. A method as claimed in claim 17, further comprising the step of determining, after service suspension, if the user equipment receives the service again and to reactivate said service if the user equipment receives the service again.

19. A method as claimed in claim 18, wherein said reactivating within the determining step comprises activating charging for said service.

20. A method as claimed in claim 10, wherein said activating step comprises activating said service that comprises a service in which data is provided to a user discontinuously.

21. A method as claimed in claim 10, wherein said activating step comprises activating said service that comprises one of a multicast service and a broadcast service.

22. A method as claimed in claim 21, wherein said activating step comprises activating said service that comprises a MBMS service.

23. A communication system comprising:
means for providing a service to at least one user equipment; and
means for determining if said service is to be provided to said at least one user equipment by a point to point connection or a point to multipoint connection, said determining means taking into account which of said at least one user equipment to which said service is providable is able to receive said service.

24. A communication system in which a service to at least one user equipment is provided, the system comprising:
a node for determining if said service is to be provided to said at least one user equipment by a point to point connection or a point to multipoint connection, said node for determining taking into account which of said at least one user equipment to which said service is providable is able to receive said service.

25. A node in a communication system in which a service is provided to at least one user equipment, the node comprising:
a configuration for said node to determine if said service is to be provided to said at least one user equipment by a point to point connection or a point to multipoint connection; and
means for determining which of said at least one user equipment to which said service is providable is able to receive said service.

26. A communication system, comprising:
activating means for activating a service which provides data to user equipment; and
suspending means for suspending said service when said user equipment is unable to receive data of said service.

27. A communication system in which a service is activated, the system comprising:
means for providing data to user equipment; and a node configured to suspend said service when said user equipment is unable to receive the data of said service.

28. A node for a communications system in which a service is activated, the node comprising:
means for providing data is provided to user equipment; and
means for suspending said service when said user equipment is unable to receive data of said service.
